(19) United States
(12) Patent Application Publication
(10) Pub. No.: US 2009/0327027 A1
(43) Pub. Date: Dec. 31, 2009

(54) METHODS AND SYSTEMS FOR TRANSFORMING LOGISTIC VARIABLES INTO NUMERICAL VALUES FOR USE IN DEMAND CHAIN FORECASTING

(76) Inventors: Arash Bateni, Toronto (CA); Edward Kim, Toronto (CA); Harminter Atwal, Framingham, MA (US); J.P Vorsanger, Toronto (CA)

Correspondence Address: JAMES M. STOVER;TERADATA CORPORATION, 2835 MIAMI VILLAGE DRIVE, MIAMISBURG, OH, 45342, US

(21) Appl. No.: 12/145,545

(22) Filed: Jun. 25, 2008

(51) Int. Cl. G06Q 10/00

(52) U.S. Cl. 705/10

(57) ABSTRACT

An improved method for forecasting and modeling product demand. The forecasting methodology employs a multivariable regression model to model the causal relationship between product demand and the attributes of past promotional activities. This improved forecasting methodology enhances the applicability of regression models when dealing with logistic variables. It provides a novel technique to transform such variables into numerical values, resulting in more accurate and more efficient regression models. Furthermore, the reduction in the number of variables improves the stability and predictive power of the regression models.

### CROSS REFERENCE TO RELATED APPLICATIONS

This application claims priority under 35 U.S.C. §119(e) to the following co-pending and commonly-assigned patent applications, which are incorporated herein by reference:

Application Ser. No. 11/613,404, entitled “IMPROVED METHODS AND SYSTEMS FOR FORECASTING PRODUCT DEMAND USING A CAUSAL METHODOLOGY,” filed on Dec. 20, 2006, by Arash Bateni, Edward Kim, Philip Liew, and J. P. Vorsanger; and

Application Ser. No. 11/938,812, entitled “IMPROVED METHODS AND SYSTEMS FOR FORECASTING PRODUCT DEMAND DURING PROMOTIONAL EVENTS USING A CAUSAL METHODOLOGY,” filed on Nov. 13, 2007, by Arash Bateni, Edward Kim, Harmintar, and J. P. Vorsanger.

### FIELD OF THE INVENTION

The present invention relates to methods and systems for forecasting product demand for retail operations, and in particular to the utilization of regression techniques and logistical variables, such as media types, in determining product demand forecasts.

### BACKGROUND OF THE INVENTION

Accurately determining demand forecasts for products are paramount concerns for retail organizations. Demand forecasts are used for inventory control, purchase planning, work force planning, and other planning needs of organizations. Inaccurate demand forecasts can result in shortages of inventory that are needed to meet current demand, which can result in lost sales and revenues for the organizations. Conversely, inventory that exceeds a current demand can adversely impact the profits of an organization. Excessive inventory of perishable goods may lead to a loss for those goods.

Teradata Corporation has developed a suite of analytical applications for the retail business, referred to as Teradata Demand Chain Management (DCM), that provides retailers with the tools they need for product demand forecasting, planning and replenishment. The Teradata Demand Chain Management applications assist retailers in accurately forecasting product sales at the store/SKU (Stock Keeping Unit) level to ensure high customer service levels are met, and inventory stock at the store level is optimized and automatically replenished. Teradata DCM helps retailers anticipate increased demand for products and plan for customer promotions by providing the tools to do effective product forecasting through a responsive supply chain.

As illustrated in FIG. 1, the Teradata Demand Chain Management analytical application suite 101 is shown to be part of a data warehouse solution for the retail industries built upon Teradata Corporation's Teradata Data Warehouse 103, using a Teradata Retail Logical Data Model (RLDM) 105. The key modules contained within the Teradata Demand Chain Management application suite 101, are:

Contribution: Contribution module 111 provides an automatic categorization of SKUs, merchandise categories and locations based on their contribution to the success of the business. These rankings are used by the replenishment system to ensure the service levels, replenishment rules and space allocation are constantly favoring those items preferred by the customer.

Seasonal Profile: The Seasonal Profile module 112 automatically calculates seasonal selling patterns at all levels of merchandise and location. This module draws on historical sales data to automatically create seasonal models for groups of items with similar seasonal patterns. The model might contain the effects of promotions, markdowns, and items with different seasonal tendencies.

Demand Forecasting: The Demand Forecasting module 113 provides store/SKU level forecasting that responds to unique local customer demand. This module considers both an item's seasonality and its rate of sales (sales trend) to generate an accurate forecast. The module continually compares historical and current demand data and utilizes several methods to determine the best product demand forecast.

Promotions Management: The Promotions Management module 114 automatically calculates the precise additional stock needed to meet demand resulting from promotional activity.

Automated Replenishment: Automated Replenishment module 115 provides the retailer with the ability to manage replenishment both at the distribution center and the store levels. The module provides suggested order quantities based on business policies, service levels, forecast error, risk stock, review times, and lead times.

Allocation: The Allocation module 116 uses intelligent forecasting methods to manage pre-allocation, purchase order and distribution center on-hand allocation.

Time Phased Replenishment: Time Phased Replenishment module 117 provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Load Builder: Load Builder module 118 optimizes the inventory deliveries coming from the distribution centers (DCs) and going to the retailer's stores. It enables the retailer to review and optimize planned loads.

Capacity Planning: Capacity Planning module 119 looks at the available throughput of a retailer's supply chain to identify when available capacity will be exceeded.

In application Ser. Nos. 11/613,404, and 11/938,812, referred to above in the CROSS REFERENCE TO RELATED APPLICATIONS, Teradata Corporation has presented improvements to the DCM Application Suite for forecasting and modeling product demand during promotional and non-promotional periods. The forecasting methodologies described in these improvements employ a causal methodology, based on multiple regression techniques, to model the effects of various factors on product demand, and hence better forecast future patterns and trends, improving the efficiency and reliability of the inventory management systems. The described forecasting techniques seek to establish a cause-effect relationship between product demand and factors influencing product demand in a market environment. Such factors may include current and recent product sales rates, seasonality of demand, product price changes, promotional activities, weather forecasts, and competitive information. A product demand forecast is generated by blending the various influencing factors in accordance with corresponding regression coefficients determined through the analysis of historical product demand and factor information.

It is desired to include logistical variables, such as media types, within the regression models utilized within product demand forecast systems and applications. Logistic variables are typically modeled through introduction of a number of binary variables, one variable for each category of the logistic variable. The increased number of variables can lead to a number of numerical problems, including increased computational time and data scarcity issues.

A novel methodology is presented herein that significantly improves the computational performance and accuracy of regression models when dealing with logistic variables.

### BRIEF DESCRIPTION OF THE DRAWINGS

FIG. 1 provides an illustration of a forecasting, planning and replenishment software application suite for the retail industries built upon Teradata Corporation's Teradata Data Warehouse.

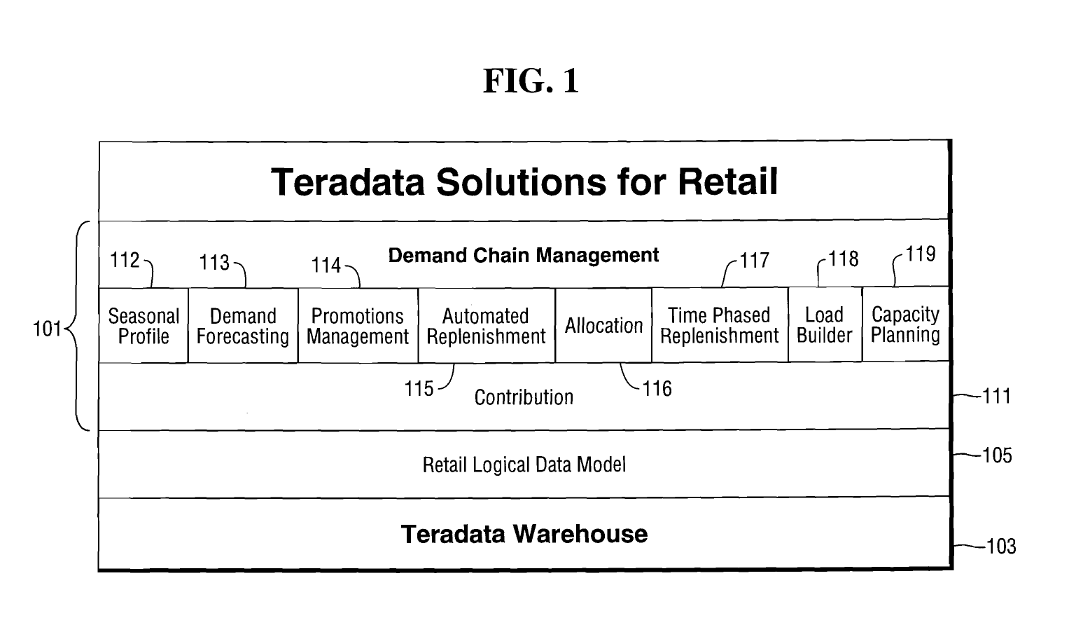

FIG. 2 is a graph illustrating the difference in product demand over time for promotional and non-promotional periods.

FIG. 3 is a flow chart illustrating a current method for determining product demand forecasts during product promotional periods.

FIG. 4 is a flow chart illustrating a method for determining product demand forecasts utilizing a multivariable regression model to model the causal relationship between product demand and the attributes of past promotional activities.

FIG. 5 is a flow chart illustrating a method for determining product demand forecasts with improved computational performance and accuracy of regression models when dealing with logistic variables in accordance with the present invention.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

In various embodiments of the present invention, product data is housed in a data store. In one embodiment, the data store is a data warehouse, such as a Teradata data warehouse, distributed by Teradata Corporation of Miamisburg, Ohio. Various data store applications interface to the data store for acquiring and modifying the product data. Of course as one of ordinary skill in the art readily appreciates, any data store and data store applications can be used with the teachings of the present disclosure. Thus, all such data store types and applications fall within the scope of the present invention.

The Teradata Demand Chain Management suites of products, as discussed above, models historical sales data to forecast future demand of products. The DCM system also generates a promotional demand forecast by multiplying a regular demand forecast by an uplift coefficient. For example, a regular, or baseline, demand forecast of 100 units with an uplift of 2.5 gives a promotional forecast of 250 units. Promotional uplift coefficients are calculated by the Automatic Event Uplift (AEU) module, which is the core of the DCM Promotions Management module 114. AEU calculates expected product demand using historical data, and then calculates a promotional uplift coefficient as the average ratio of the historical promotional demand over the regular, non-promotional product demand.

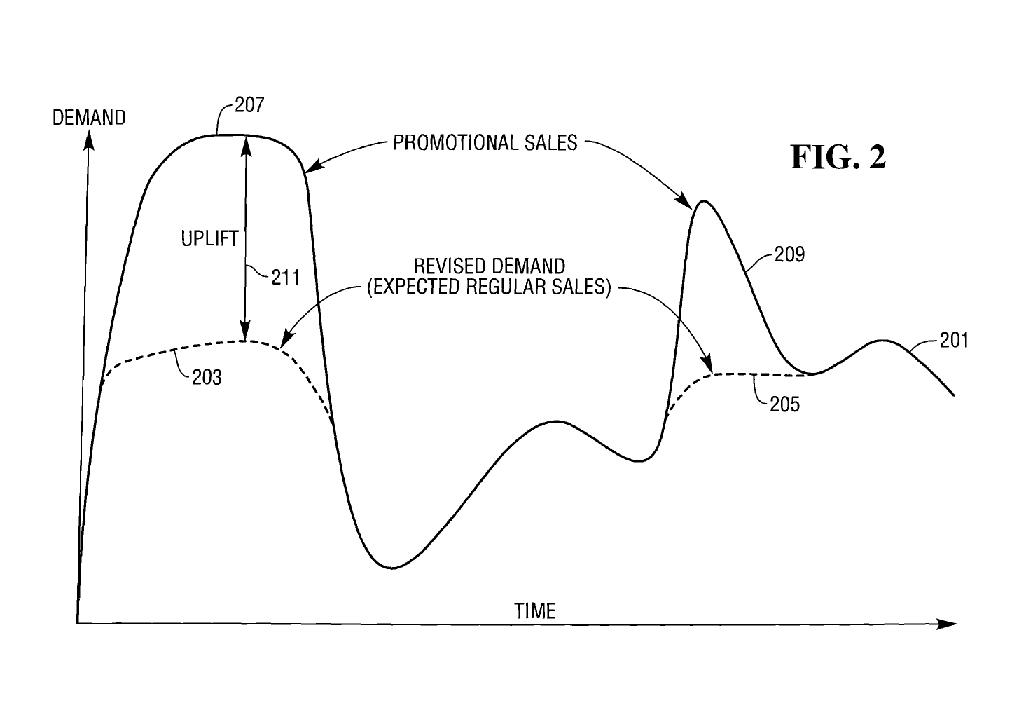

A graph illustrating the difference in product demand over time for promotional and non-promotional periods is provided in FIG. 2. Graph 201, including graph segments 203 and 205, illustrates the regular sales activity for an exemplary product. Promotional product sales activity is represented by graph segments 207 and 209. The increase in demand over regular sales activity during the promotional periods represented by graph section 207 and 209 is referred to as the promotional uplift.

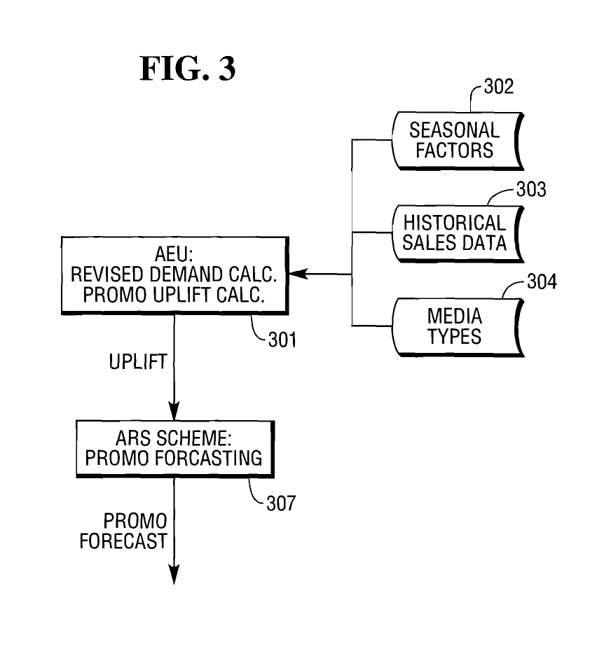

FIG. 3 is a simple flow chart illustrating a current method for determining product demand forecasts during product promotional periods. As part of the DCM demand forecasting process, seasonal adjustment factors 302, historical sales data 303, and other information, such as media types 304, are saved for each product or service offered by a retailer. Media types 304 can represent types of promotions used for promoted products. For example, a media type can be advertisements made for the promoted product through a print media (e.g., newspaper), online media (e.g., electronic mail (email), World-Wide Web (WWW), and the like), telemarketing, postal mail, television, and others.

In step 301, the Automatic Event Uplift (AEU) module, which is the core of the DCM Promotion Manager module 114, calculates the regular demand forecast using the historical data 303, and then calculates the promotional uplift coefficient as the average ratio of the historical promotional demand over the regular, non-promotional, demand.

In step 307, the promotional uplift is then input into the DCM Average Rate of Sale (ARS) calculations performed within the Demand Forecasting module 113 to estimate the promotional demand forecast.

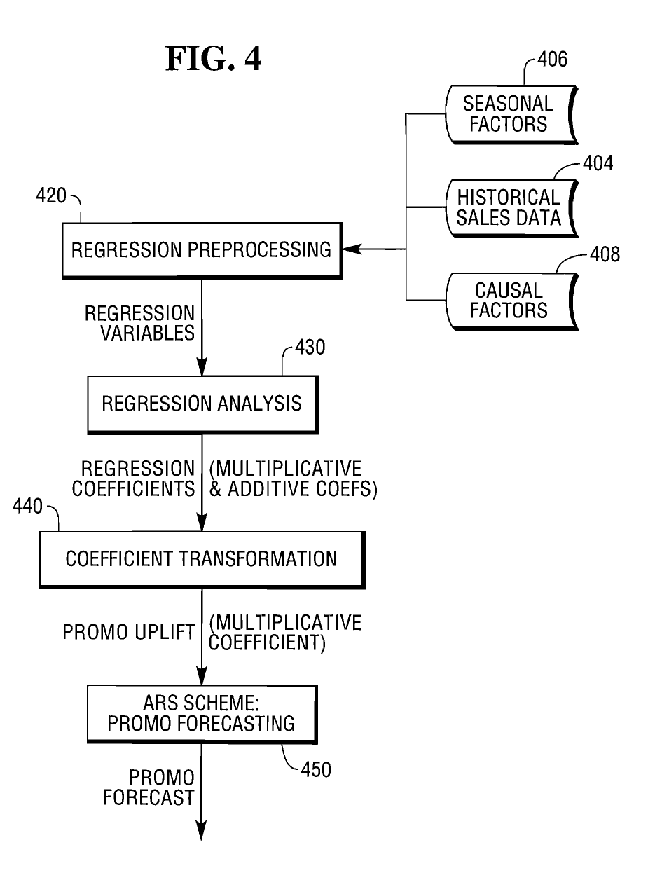

FIG. 4 is a flow chart illustrating a casual method for forecasting promotional product demand, as described in greater detail in U.S. patent application Ser. No. 11/938,812, referred to above. The demand forecasting technique described therein employs a multivariable regression model to model the causal relationship between product demand and the attributes of past promotional activities. The model is utilized to calculate the promotional uplift from the coefficients of the regression equation. The methodology consists of two main steps a) regression: calculation of regression coefficients, and b) coefficient transformation: calculation of the promo uplift.

The methodology utilizes a mathematical formulation that transforms regression coefficients into a single promotional uplift coefficient that can be used by the DCM system for promotional demand forecasting. The multivariable regression equation can be expressed as:

demand=a+b·promoflag+c·price+ . . .

The above equation includes causal variables promoflag, a binary flag indicating whether there is a promotion, and price, the unit price for a given week. Regression coefficients included in equation 1 are: a, an intercept; b, an uplift due to promotion; and c, a multiplicative price elasticity. Multiple promoflag variables, and causal variables and regression coefficients in addition to those shown in equation 1 may be included in equation 1.

Referring again to FIG. 4, historical sales data 404, seasonal adjustment factors 406, and tracked causal factors 408, are saved for each product or service offered by the retailer.

In steps 420 and 430, regression coefficients (a, b, c, d, . . . ) are calculated using historical sales data 404, seasonal adjustment factors 406, and tracked causal factors 408. These regression coefficients are combined in step 440 to generate a single, multiplicative promotional uplift coefficient.

In step 450, the promotional uplift is then input into the DCM Average Rate of Sale (ARS) calculations performed within the Demand Forecasting module 113 to estimate the promotional demand forecast.

As stated above, it is desired to include categorical, or logistical, variables within the regression models utilized within product demand forecast systems and applications. Categorical variables play a key role in Teradata Demand Chain Management applications. Various factors such as media types, decays, weather, discount rage, and contribution codes are often modeled as categorical variables. These variables are typically modeled through introduction of a number of binary variables, one variable for each category of the logistic variable. The increased number of variables can lead to a number of numerical problems, including increased computational time and data scarcity issues.

The technique described herein transforms the logistic variables into a single numerical value through a novel weight calculation technique, that is, by calculating the relative effect of each category of the logistic variable on the response variable. As a result, both the efficiency and accuracy of the regression model is significantly improved.

An immediate application of this invention is to model media types to calculate promotional uplift or to forecast product demand using a regression model. Media types are codes or labels, e.g., from 0 to 99, indicating the advertisement methods; where 0 indicates no advertisement, i.e., regular sales, and other labels show different advertisement methods or combinations of methods.

As discussed above, a typical regression equation in the absence of media types is:

y=a+b·promoflag+c·price+ . . . (EQN.1)

where y is demand, promoflag is a binary flag indicating whether there is a promotion, price is the unit price, and a, b and c are regression coefficients.

When media types are included in the regression equation, normally one regression variable must be defined for each category of the logistic variables. The regression equation becomes:

$$y = a + {\sum }_{i = 1}^{n} {b}_{i} \cdot {promoflag}_{i} + c \cdot price + … \qquad ( EQN . 2 )$$

where promoflagᵢ is a binary flag corresponding to the media type i, and bᵢ is the regression uplift for that media type.

The increase in the number of variables contained in the regression equation due to the inclusion of media types causes various numerical problems, including increased computational time, and data scarcity issues. To address these problems, a novel technique is proposed to transform the logistic variables, e.g., media types, into a numerical value. In accordance with this technique, the regression equation can be defined as:

y=a+b.promo₁+c.price+ . . . (EQN.3)

where:
i refers to the media type.
b is the regression coefficient (the base uplift) and is constant for all media types. It has the same dimension as y, e.g., units of product when y is demand.
promo₁ is a multiplicative coefficient that determines the weight or the relative effect of the media type i. This coefficient is dimensionless.
And b.promo₁ is the regression estimator (est₁) for the additive promo uplift:

b.promo₁=est₁(liftᵢ) (EQN.4)
where b.promoᵢ has the same dimension as y, e.g., units of product when y is demand.

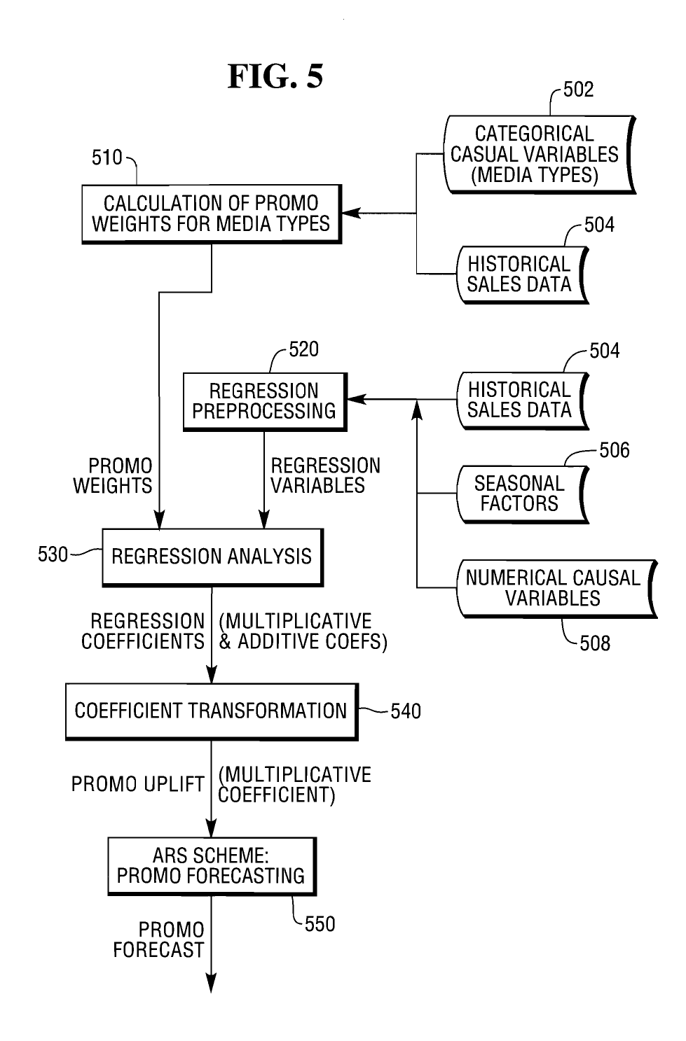

The key for deriving the mathematical formulation is the calculation of promo weights, promo₁, for each media type. Promo weights are to be calculated first and fed to the regression model. Hence an additional relation, next to the regression equation, is required. An improved casual method for forecasting promotional product demand, which includes steps for calculating promo weights for multiple media types and determining a regression coefficient for the media types is illustrated in the flow chart of FIG. 5.

Referring to FIG. 5, media type data (media types and promotional dates) 502, historical sales data 504, seasonal factors 506, and tracked causal factors 508, are saved for each product or service offered by the retailer.

In step 510 promo weights are calculated for each media type using media type data 502 and historical sales data 504. In step 520, regression variables other than those associated with media types are calculated using historical sales data 504, seasonal factors 506, and causal factors 508. The promo weights from step 510, and regression variables from step 520 are provided to step 530, where regression analysis is used to calculate regression coefficients (a, b, c, d, . . . ).

The regression coefficients are combined in step 540 to generate a single, multiplicative promotional uplift coefficient. In step 550, the promotional uplift is then input into the DCM Average Rate of Sale (ARS) calculations performed within the Demand Forecasting module 113 to estimate the promotional demand forecast.

The relation set forth in EQN.4, used in the calculation of promo weights, may be derived using the assumption that the change in the average demand due to a media type is a sufficient estimator (est₂) for calculation of promo weights, i.e., the relative effect of the media types. Thus:

y̅ᵢ− y̅₀=est₂(liftᵢ) (EQN.5)

where y̅ᵢ is the average sales for media type i, and y̅₀ is the average regular sales.

The above relation, EQN.5, is generally applicable for transforming the logistic variables into numerical ones. It may potentially be replaced by more accurate relations that are applicable to particular cases. The above estimator, est₂, is not as accurate as the regression estimator, est₁, so it is only used for calculation of the promo weights. The actual uplift, b, is calculated through the regression model.

The relations:

b.promoᵢ=est₁(liftᵢ), i=1, 2, 3, . . . , n (EQN.4); and

y̅ᵢ− y̅₀=est₂(liftᵢ), i=1, 2, 3, . . . , n (EQN.5)

form a system of n (number of media types) equations for which b and promo₅ are unknown. This system of equations is “underdetermined”, since there are n equations and n+1 unknown variables. However, setting promo₁=1 in EQN.4 yields:

$$\begin{matrix}\begin{matrix}b \cdot {promo}_{1} = {est}_{1} ( {lift}_{1} ) \\ {promo}_{1} = 1\end{matrix} \} ⇒ b = {est}_{1} ( {lift}_{1} ) \\ b \cdot {promo}_{i} = {est}_{1} ( {lift}_{i} ) ⇒ {promo}_{i} = \frac{{est}_{1} ( {lift}_{i} )}{b}\end{matrix} \} ⇒ {promo}_{i} = \frac{{est}_{1} ( {lift}_{i} )}{{est}_{1} ( {lift}_{1} )} = {est}_{1} ( \frac{{lift}_{i}}{{lift}_{1}} )$$

and, from the assumption that est₂ is a sufficient estimator for promo calculation:

$${est}_{1} ( \frac{{lift}_{i}}{{lift}_{1}} ) \approx {est}_{2} ( \frac{{lift}_{i}}{{lift}_{1}} ) = \frac{{\overline{y}}_{i} - {\overline{y}}_{0}}{{\overline{y}}_{1} - {\overline{y}}_{0}}$$

$$and {promo}_{i} \approx \frac{{\overline{y}}_{i} - {\overline{y}}_{0}}{{\overline{y}}_{1} - {\overline{y}}_{0}} .$$

### CONCLUSION

The Figures and description of the invention provided above reveal a novel system utilizing a causal methodology, based on multivariable regression techniques, to determining product demand forecasts. This invention enhances the applicability of regression models when dealing with logistic (categorical) variables. It provides a novel technique to transform such variables into numerical values, resulting in more accurate and more efficient regression models. Furthermore, the reduction in the number of variables improves the stability and predictive power of the regression models. It is not intended to be exhaustive or to limit the invention to the precise form disclosed. Many alternatives, modifications, and variations will be apparent to those skilled in the art in light of the above teaching. Accordingly, this invention is intended to embrace all alternatives, modifications, equivalents, and variations that fall within the spirit and broad scope of the attached claims.

What is claimed is:

1. A method for forecasting demand for a product, the method comprising the steps of:
maintaining a database of historical product demand information;
identifying a plurality of factors influencing demand for said product, said factors including a categorical variables and non-categorical variables;
transforming categorical values of said categorical variables into numerical values;
analyzing said historical product demand information for said product to determine a regression coefficient corresponding to said categorical variables and a regression coefficient corresponding to each one of said non-categorical variables; and
blending said regression coefficients, projected numerical values of said categorical variables, and values of said non-categorical variables for said product to determine a product demand forecast for said product.

2. The method for forecasting demand for a product in accordance with claim 1, wherein said step of transforming said categorical values into numerical values comprises:
analyzing said historical product demand information and historical categorical values of said categorical variables associated with said product to determine the relative effect of each categorical value on sales of said product; and
assigning a numerical value to each one of said categorical values corresponding to the relative effect of each one of said categorical values on sales of said product.

3. The method for forecasting demand for a product in accordance with claim 2, wherein said categorical variables comprise media types, and said categorical values comprise a plurality of binary values, one binary value for each one of said media types.

4. The method for forecasting demand for a product in accordance with claim 3, wherein said media types represent types of promotions used for promoted products, including one or more of the following:
advertisements made for the promoted product through a print media;
advertisements made for the promoted product through online media;
advertisements made for the promoted product via telemarketing;
advertisements made for the promoted product through postal mail; and
advertisements made for the promoted product through television.

5. A computer program, stored on a tangible storage medium, for forecasting demand for a product, the program including executable instructions that cause a computer to:
retrieving historical product demand information from a computer database;
identifying a plurality of factors influencing demand for said product, said factors including a categorical variables and non-categorical variables;
transforming categorical values of said categorical variables into numerical values;
analyzing said historical product demand information for said product to determine a regression coefficient corresponding to said categorical variables and a regression coefficient corresponding to each one of said non-categorical variables; and
blending said regression coefficients, projected numerical values of said categorical variables, and values of said non-categorical variables for said product to determine a product demand forecast for said product.

6. The compute program, stored on a tangible storage medium, in accordance with claim 5, wherein said step of transforming said categorical values into numerical values comprises:
analyzing said historical product demand information and historical categorical values of said categorical variables associated with said product to determine the relative effect of each categorical value on sales of said product; and
assigning a numerical value to each one of said categorical values corresponding to the relative effect of each one of said categorical values on sales of said product.

7. The compute program, stored on a tangible storage medium, in accordance with claim 6, wherein said categorical variables comprise media types, and said categorical values comprise a plurality of binary values, one binary value for each one of said media types.

8. The compute program, stored on a tangible storage medium, in accordance with claim 7, wherein said media types represent types of promotions used for promoted products, including one or more of the following:
advertisements made for the promoted product through a print media;
advertisements made for the promoted product through online media;
advertisements made for the promoted product via telemarketing;
advertisements made for the promoted product through postal mail; and
advertisements made for the promoted product through television.
